(19) United States
(12) Patent Application Publication
(10) Pub. No.: US 2010/0123685 A1
(43) Pub. Date: May 20, 2010

(54) TACTILE PRESENTATION TOUCH SCREEN AND DISPLAY DEVICE HAVING THE SAME

(75) Inventors: Kyungno Lee, Seoul (KR); Il-Kweon Joung, Seongnam-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/482,735

(22) Filed: Jun. 11, 2009

(30) Foreign Application Priority Data
Nov. 18, 2008 (KR) 10-2008-0114834

(51) Int. Cl. G06F 3/043

(52) U.S. Cl. 345/177

(57) ABSTRACT

A tactile presentation touch screen and a display device having the same is disclosed. The tactile presentation touch screen in accordance with an embodiment of the present invention includes a transparent piezoelectric body, a plurality of transparent electrodes, which are coupled to the transparent piezoelectric body such that the transparent piezoelectric body is divided into grids, and a touch screen unit, which is coupled to one surface of the transparent piezoelectric body. Thus, the tactility of the touch screen can be improved by deforming the transparent piezoelectric body corresponding to an area pressed by the user.

### CROSS-REFERENCE TO RELATED APPLICATIONS

This application claims the benefit of Korean Patent Application No. 10-2008-0114834, filed with the Korean Intellectual Property Office on Nov. 18, 2008, the disclosure of which is incorporated herein by reference in its entirety.

### BACKGROUND

1. Technical Field

The present invention relates to a tactile presentation touch screen and a display device having the touch screen.

2. Description of the Related Art

A touch screen is a kind of input device that can transmit an input signal, which typically corresponds to a certain area, to an electronic device equipped with the touch screen, when the certain area is pressed by a hand of the user or a stylus.

However, when the user touches the certain area of the touch screen, it is difficult for the user to know whether the tactile inputting on the touch screen has been made correctly or not since the user has no feedback from the touch screen.

To solve the above problem, some of the new electronic devices having a touch screen are equipped with a vibrating motor that is activated to vibrate the device to provide the feedback to the user when the touch panel is touched. Nevertheless, the user still does not know whether or not the feedback is from the very area pressed by the user.

### SUMMARY

The present invention provides a tactile presentation touch screen and a display device equipped with the tactile presentation touch screen that can provide feedback for an area pressed by the user.

An aspect of the present invention provides a tactile presentation touch screen. The tactile presentation touch screen in accordance with an embodiment of the present invention includes a transparent piezoelectric body, a plurality of transparent electrodes, which are coupled to the transparent piezoelectric body such that the transparent piezoelectric body is divided into grids, and a touch screen unit, which is coupled to one surface of the transparent piezoelectric body.

The plurality of transparent electrodes can divide the transparent piezoelectric body into a pattern of grids.

The tactile presentation touch screen can further comprise a processer, which supplies a driving voltage to the transparent electrode corresponding to a pressed area of the touch screen unit, and the driving voltage can deform or vibrate a portion of the transparent piezoelectric body corresponding to the pressed area.

Another aspect of the present invention provides a display device. The display device in accordance with an embodiment of the present invention includes a transparent piezoelectric body, a plurality of transparent electrodes, which are coupled to the transparent piezoelectric body such that the transparent piezoelectric body is divided into grids, a touch screen unit, which is coupled to one surface of the transparent piezoelectric body, and a video display panel unit, which is coupled to one surface of the touch screen unit.

The plurality of transparent electrodes can divide the transparent piezoelectric body into a pattern of grids.

The tactile presentation touch screen can further comprise a processer, which supplies a driving voltage to the transparent electrode corresponding to a pressed area of the touch screen unit, and the driving voltage can deform or vibrate a portion of the transparent piezoelectric body corresponding to the pressed area.

When an icon is displayed on the video display panel unit, the processor can supply the driving voltage to the transparent electrode corresponding to an area where the icon is displayed, and the driving voltage can deform the transparent piezoelectric body corresponding to the area where the icon is displayed.

Moreover, a plurality of icons are displayed on the video display panel unit, and the driving voltage can deform a plurality of portions of the transparent piezoelectric body in a different direction from one another, in which the plurality of portions of the transparent piezoelectric body correspond to areas where the plurality of icons are displayed.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a perspective view of a display device in accordance with an embodiment of the present invention.

FIG. 2 is an exploded perspective view of a display device in accordance with an embodiment of the present invention.

FIG. 3 is a side view of a transparent piezoelectric body in accordance with an embodiment of the present invention.

FIG. 4 illustrates a brief structure of a display device in accordance with an embodiment of the present invention.

FIG. 5 is a side view illustrating an operation of a transparent piezoelectric body in accordance with an embodiment of the present invention.

FIG. 6 is a perspective view illustrating an operation of a display device in accordance with an embodiment of the present invention.

FIG. 7 is a side view illustrating an operation of a transparent piezoelectric body in accordance with an embodiment of the present invention.

FIG. 8 is a side view illustrating another operation of a transparent piezoelectric body in accordance with an embodiment of the present invention.

### DETAILED DESCRIPTION

The features and advantages of this invention will become apparent through the below drawings and description.

A display device according to a certain embodiment of the present invention will be described below in more detail with reference to the accompanying drawings. Those components that are the same or are in correspondence are rendered the same reference numeral regardless of the figure number, and redundant descriptions are omitted.

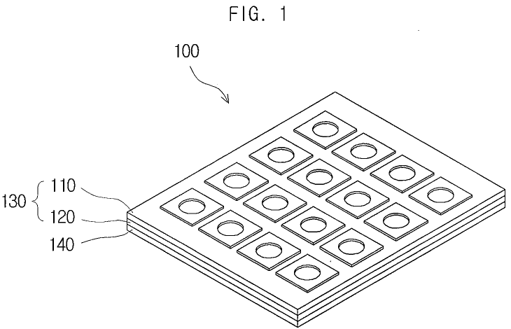

FIG. 1 is a perspective view of a display device 100 in accordance with an embodiment of the present invention. As illustrated in FIG. 1, the display device 100 in accordance with an embodiment of the present invention includes a transparent piezoelectric body 110, a plurality of transparent electrodes 112, which are coupled to the transparent piezoelectric body 110 such that the transparent piezoelectric body 110 is divided into grids, a touch screen unit 120, which is coupled to one surface of the transparent piezoelectric body 110, and a video display panel unit 140, which is coupled to one surface of the touch screen unit 120. The tactility of the display device 100 can be improved by deforming or vibrating a transparent vibrating body at which the user presses.

The display device 100 can be mounted on various types of electronic devices and function not only as an output unit of the electronic device but also as an input unit. If the video display panel unit 140 is omitted from the display device 100, a tactile presentation touch screen 130 with no video display unit can be formed. Accordingly, it shall be evident that the tactile presentation touch screen 130 can be used as a touch screen providing tactility while being mounted on a front surface of a conventional video display device.

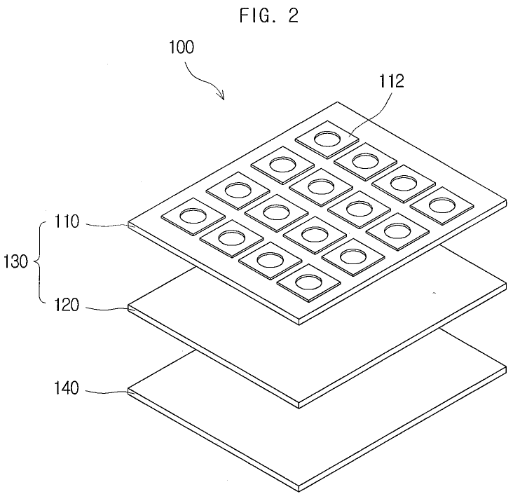

FIG. 2 is an exploded perspective view of the display device 100 in accordance with an embodiment of the present invention. As illustrated in FIG. 2, the video display panel unit 140 is coupled to the lowest layer of the display device 100.

The video display panel unit 140 is a part that displays video, like an LCD panel, and can function as an output unit of the electronic device equipped with the display device 100. The video display panel unit 140 can display various forms of video such as an icon, which is an object to be selected by the user.

The touch screen unit 120 is coupled to one surface of the video display panel unit 140. When a certain area of the touch screen unit 120 is pressed by the user, the touch screen unit 120 can function as an input unit that can transmit information about the presence and location of a touch to a processor.

The transparent piezoelectric body 110 can be formed in the shape of a panel, like the touch screen unit 120 or the video display panel unit 140. The transparent piezoelectric body 110 is coupled to one surface of the touch screen unit 120. The transparent piezoelectric body 110 can be made of, for example, lead lanthanum zirconate titanate (PLZT) or lead magnesium niobate-lead titanate (PMN-PT).

The transparent piezoelectric body 110 can be driven in various ways, for example, by vibrating or deforming the transparent piezoelectric material 110 to a specific shape, depending on the driving voltage being supplied. As a result, the user can sense a variety of tactility while using the display device 100.

The transparent electrode 112 is coupled to one surface of the transparent piezoelectric body 110 and can divide the transparent piezoelectric body 110 into a pattern of grids. The transparent electrode 112 is a part that provides an electrical connection to the transparent piezoelectric body 110. Although the transparent electrode 112 can be implemented in various forms, the transparent electrode 112 of the present embodiment is in the shape of a square, of which the center is formed with a circular hollow part.

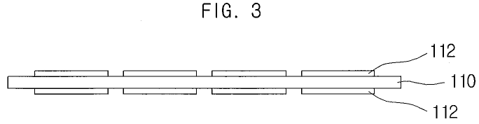

FIG. 3 is a side view showing the transparent piezoelectric body 110 in accordance with an embodiment of the present invention. As illustrated in FIG. 3, the transparent electrode 112 can be coupled to both surfaces of the transparent piezoelectric body 110. The transparent electrode 112 is disposed in a rectangular pattern on the transparent piezoelectric body 110, thereby electrically dividing the transparent piezoelectric body 110 into grids. The transparent electrode 112 provides the electrical connection to a specific area of the transparent piezoelectric body 110 and allows only the specific area to be vibrated, thereby dividing the transparent piezoelectric body 110 into grids.

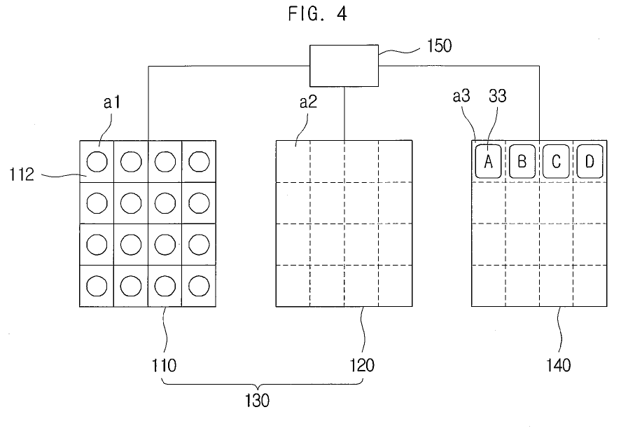

FIG. 4 illustrates a brief structure of the display device in accordance with an embodiment of the present invention. As illustrated in FIG. 4, a processor 150 can have an electrical connection with, and control the operation of, the transparent piezoelectric body 110, the touch screen unit 120 and the video display panel unit 140. The processor 150 can be constituted as a part of processor of the electronic device to which the display device 100 is equipped.

The processor 150 can supply a driving voltage to the transparent electrode 112 corresponding to the pressed area of the touch screen unit 120. An icon 33, which can be used for inputting by the user, can be displayed on a specific area a3 of the video display panel unit 140.

Accordingly, the user can touch a specific area a2 of the touch screen unit 120, and the processor 150 can receive a signal with respect to the touched area from the touch screen unit 120 and supply a driving voltage to the transparent electrode 112 corresponding to a specific area a1. Here, the driving voltage can have various forms. For example, the processor 150 can supply the driving voltage such that the transparent piezoelectric body 110 is vibrated, and thus the user can sense the tactility when touching the touch screen unit 120.

If the user touches a number of areas on the touch screen unit 120, the processor 150 can supply the driving voltage to each of the transparent electrodes 112 corresponding to the touched areas and thus provide individual tactility to the user.

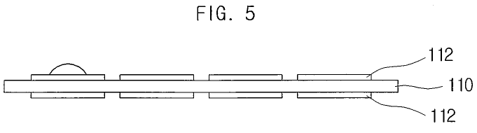

FIG. 5 is a side view illustrating an operation of the transparent piezoelectric body in accordance with an embodiment of the present invention. As illustrated in FIG. 5, the processor 150 can supply the driving voltage to the transparent electrode 112 such that the transparent piezoelectric body 110 is deformed. When the driving voltage is supplied to the transparent electrode 112, the transparent piezoelectric body 110 corresponding to the transparent electrode 112 can maintain the deformed state, depending on the direction of polarization.

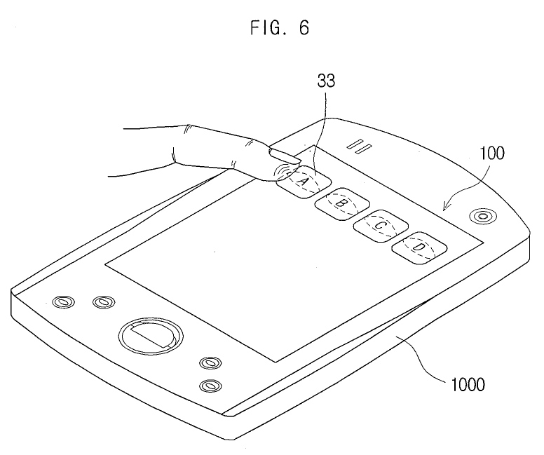

FIG. 6 is a perspective view illustrating an operation of the display device 100 in accordance with an embodiment of the present invention. As illustrated in FIG. 6, the display device 100 can be used as an input unit and an output unit of an electronic device, such as a mobile device, a GPS navigation device, a game player and an ATM machine.

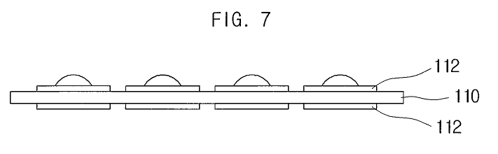

Such an electronic device 1000 can display the icon 33 through the video display panel unit 140 in order to receive an input from the user. FIG. 7 is a side view illustrating an operation of the transparent piezoelectric body in accordance with an embodiment of the present invention. As illustrated in FIGS. 6 and 7, the processor 150 can make the transparent piezoelectric body 110 bulge out, by supplying a voltage to the transparent electrode 112 corresponding to the area where the icon 33 is displayed. Therefore, the user can sense distinctive tactility of the area where the icon 33 is being recognized when selecting the icon 33.

Additionally, when the user selects the particular icon 33 and presses the location of the touch screen unit 120 where the icon 33 is displayed, a voltage can be supplied to the corresponding transparent electrode 11-2 such that the transparent piezoelectric body 110 corresponding to the pressed area is vibrated, as described above.

Therefore, the user can sense not only the tactility of the bulged area where the icon 33 is displayed but also the sense of touch through the vibration of the transparent piezoelectric body 110.

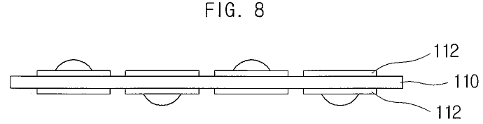

FIG. 8 is a side view illustrating another operation of the transparent piezoelectric body in accordance with an embodiment of the present invention. Not only does the processor 150 make the transparent piezoelectric body 110 bulge out, but the processor 150 supplies a driving signal to the transparent electrode 112 such that the portion of the transparent piezoelectric body 110 adjacent to the bulged-out portion of the transparent piezoelectric body 110 is deformed in a different direction, as illustrated in FIG. 8.

Therefore, by supplying the driving voltage to the transparent electrode 112 corresponding to the area where the icon 33 is displayed, each of the adjacent portions of the transparent piezoelectric body 110 can be deformed to bulge out (convex) or bulge in (concave) in a vertical direction.

In this case, if the user drags his or her finger on the transparent piezoelectric body 110, the user can repeatedly sense the transparent piezoelectric body 110 that is alternately deformed convexly and concavely, allowing the user to sense the tactility of dragging a rough surface.

While the spirit of the invention has been described in detail with reference to a particular embodiment, the embodiment is for illustrative purposes only and shall not limit the invention. It is to be appreciated that those skilled in the art can change or modify the embodiment without departing from the scope and spirit of the invention. As such, many embodiments other than that set forth above can be found in the appended claims.

What is claimed is:

1. A tactile presentation touch screen comprising:
a transparent piezoelectric body;
a plurality of transparent electrodes coupled to the transparent piezoelectric body such that the transparent piezoelectric body is divided into grids; and
a touch screen unit coupled to one surface of the transparent piezoelectric body.

2. The tactile presentation touch screen of claim 1, wherein the plurality of transparent electrodes divide the transparent piezoelectric body into a pattern of grids.

3. The tactile presentation touch screen of claim 1, further comprising a processer configured to supply a driving voltage to the transparent electrode corresponding to a pressed area of the touch screen unit.

4. The tactile presentation touch screen of claim 3, wherein the driving voltage deforms or vibrates a portion of the transparent piezoelectric body corresponding to the pressed area.

5. A display device comprising:
a transparent piezoelectric body;
a plurality of transparent electrodes coupled to the transparent piezoelectric body such that the transparent piezoelectric body is divided into grids;
a touch screen unit coupled to one surface of the transparent piezoelectric body; and
a video display panel unit coupled to one surface of the touch screen unit.

6. The display device of claim 5, wherein the plurality of transparent electrodes divide the transparent piezoelectric body into a pattern of grids.

7. The display device of claim 5, further comprising a processer configured to supply a driving voltage to the transparent electrode corresponding to a pressed area of the touch screen unit.

8. The display device of claim 7, wherein the driving voltage vibrates a portion of the transparent piezoelectric body corresponding to the pressed area.

9. The display device of claim 7, wherein an icon is displayed on the video display panel unit, and the processor supplies the driving voltage to the transparent electrode corresponding to an area where the icon is displayed.

10. The display device of claim 9, wherein the driving voltage deforms the transparent piezoelectric body corresponding to the area where the icon is displayed.

11. The display device of claim 9, wherein:
a plurality of icons are displayed on the video display panel unit, and
the driving voltage deforms a plurality of portions of the transparent piezoelectric body in a different direction from one another, the plurality of portions of the transparent piezoelectric body corresponding to areas where the plurality of icons are displayed.
